(19) United States
(12) Patent Application Publication
(10) Pub. No.: US 2025/0389575 A1
(43) Pub. Date: Dec. 25, 2025

(54) Secondary Offset Calibration

(71) Applicant: Itron, Inc., Liberty Lake, WA (US)

(72) Inventors: Maxwell David Anstett, Pendelton, SC (US); David Patrick Beaudreau, Easley, SC (US)

(21) Appl. No.: 18/752,342

(22) Filed: Jun. 24, 2024

(51) Int. Cl. G01F 25/10

(52) U.S. Cl. CPC G01F 25/10

(57) ABSTRACT

A method and a system for improving measurement accuracy of a meter previously calibrated are provided. A region over a measurement range of the meter is defined based at least in part on a plurality of calibration points utilized to previously calibrate the meter, where the region includes a first calibration constant and a second calibration constant. A quantity output of the meter is recalibrated by: selecting one or more recalibration points within the region; measuring one or more corresponding error factors at the one or more recalibration points; and determining a revised second calibration constant based on the one or more corresponding error factors and the second calibration constant. The recalibrated quantity output of the meter is then generated based on a measured quantity output by the meter, the first calibration constant, and the revised second calibration constant.

### TECHNICAL FIELD

The present disclosure generally relates to the field of meter calibration, and more specifically to a system and method for a secondary offset calibration of a meter utilized after a primary calibration of the meter, such as by a piecewise linear calibration, for further improving accuracy of the meter.

### BACKGROUND

A meter designed to measure flow rates of fluid, such as a gas meter with an ultrasonic measurement unit may be calibrated utilizing piecewise linear calibration. For example, piecewise delineations may be determined by selecting n calibration points, Q₁, Q₂, . . . , Qₙ, which are values or quantities to be measured for calibration, and evaluating the accuracy of the meter, as error factors, e_{q1}, e_{q2}, . . . , e_{qn} at the corresponding calibration points. An error factor, eq, is determined by comparing a measured value, Qₘₑₐₛ, of an uncalibrated meter to an actual value measured under the same conditions by a more precise piece of equipment. The meter may then be calibrated by applying a calibration factor, which is calculated based on a corresponding calibration point and a corresponding error factor, to yield a more accurate result. Because the measurement errors are compensated by the calibration factors calculated at the calibration points, the calibrated outputs at the calibration points are adjusted, or compensated, to have error values of 0%. Measurement values between two adjacent calibration points are then adjusted by a calibration factor linearized between the adjacent calibration points.

However, the piecewise linear calibration may not be able to adequately correct, or reduce, measurement errors to be within predefined values over a measurement range of a given meter. Because the errors are already adjusted to 0% at the calibration points, repeating the same piecewise linear calibration would not further improve the measurement accuracy of the meter. Based on the capability of existing devices, such as memory size and meter configuration, it may not be possible to utilize more calibration points for the initial piecewise linear calibration and/or utilize additional and different calibration points for repeating the piecewise linear calibration.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a simplified meter calibration system.

FIG. 2 illustrates two graphs: one graph with an example error rate line of an uncalibrated meter and an example error correction line based on the piecewise linear calibration and another graph with an example calibrated error rate line.

FIG. 3 illustrates a comparison graph with an error correction line based on the piecewise linear calibration and an error correction line based on the piecewise linear calibration with a secondary offset calibration.

FIG. 4 illustrates error rate lines of the initial piecewise linear calibration and a recalibrated error rate line after the piecewise linear calibration along with accuracy limits of the meter.

FIG. 5 illustrates a first portion of an example flowchart for a secondary offset calibration process of a meter after the meter is calibrated by utilizing a piecewise linear calibration.

FIG. 6 illustrates a second portion of the example flowchart for the secondary offset calibration process of the meter after the meter is calibrated by utilizing the piecewise linear calibration.

### DETAILED DESCRIPTION

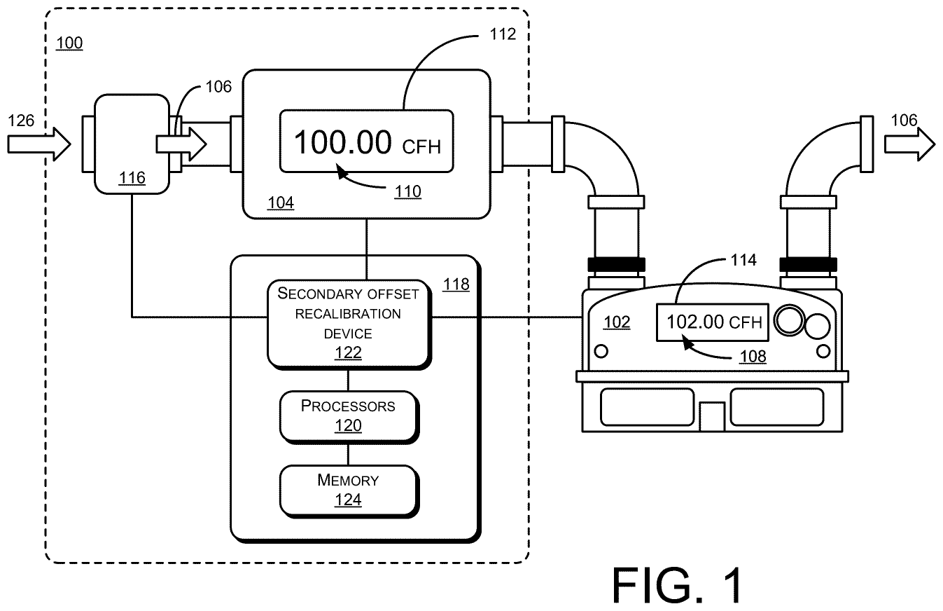

FIG. 1 illustrates a simplified example meter calibration system 100. A meter 102 to be calibrated is shown to be connected in series to a reference meter 104 of the meter calibration system 100. Fluid of a certain regulated volume rate 106 flows through the reference meter 104 and the meter 102, and a measured volume rate 108 by the meter 102 is compared to a volume rate measured 110 by the reference meter 104. A volume rate measured by the reference meter 104 is treated as a known and accurate measure of the volume rate. In this example, the reference meter 104 shows on a reference display 112 the volume rate to be 100 cubic feet per hour (CFH or ft³/h), which is the regulated volume rate 106 and is taken to be the actual volume rate. In contrast, the meter 102 shows on a meter display 114 a measured volume rate of the regulated volume rate 106 to be 102 CFH, which is 2% over the actual volume rate of 100 CFH and requires 2% correction. For a piecewise linear calibration, the process described above may be repeated at several volume rates, or calibration points.

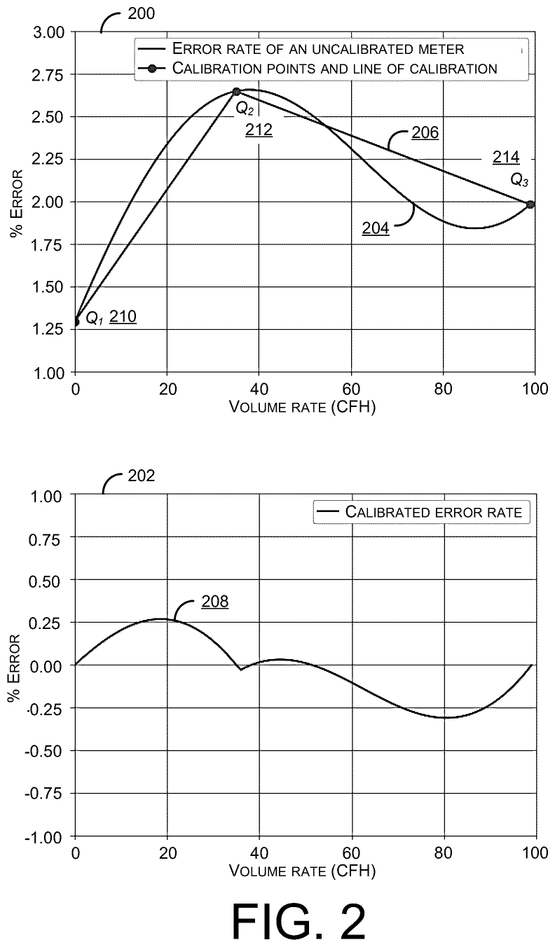

The meter calibration system 100 may additionally comprise a flow regulator 116 coupled to the reference meter 104, and controller 118 coupled to the reference meter 104 and the flow regulator 116. The controller 118 may be additionally coupled to a meter to be recalibrated, such as the meter 102, which is coupled to the reference meter 104. The controller 118 may comprise one or more processors (processors) 120, a secondary offset recalibration device 122 coupled to the processors 120, and memory 124 coupled to the processors 120. The memory 124 may store computer-executable, or processor-executable, instructions that, when executed by the processors 120, cause the processors 120 to perform operations. For example, the processors 120 may control, or instruct, the secondary offset recalibration device 122 coupled to the flow regulator 116 to regulate fluid flow 126 into the reference meter 104 and produce regulated flow, such as the regulated volume rate 106. The secondary offset recalibration device 122 may obtain the volume rate measured 110 by the reference meter 104 and further regulate the fluid flow 126 to achieve a desired regulated volume rate. The secondary offset recalibration device 122 may also be coupled to the meter 102 and obtain the measured volume rate 108 by the meter 102. The meter calibration system 100 may perform operations described below with reference to FIGS. 2-6.

FIG. 2 illustrates two graphs 200 and 202. The graph 200 is shown with an uncalibrated error rate line 204 of an uncalibrated meter, such as the meter 102, and an example error correction line 206 based on the piecewise linear calibration. The graph 202 is shown with an example calibrated error rate line 208 after the piecewise linear calibration. Piecewise delineations are determined by evaluating the accuracy of the meter, as error factors, e_{q1}, e_{q2}, . . . , e_{qn} at n calibration points, Q₁, Q₂, . . . , Qₙ, where e_{q} is determined by comparing a measured value of the meter 102 at a calibration point to an actual value measured by reference meter 104 at the same calibration point as discussed above with reference to FIG. 1. In this example, 0 CFH, 35 CFH, and 100 CFH are used as the calibration points, Q₁ 210, Q₂ 212, and Q₃ 214, where the error factors, e_{qp1}, e_{qp2}, and e_{qp3}, corresponding to the calibration points are 1.3%, 2.6%, and 2%. For example, the measured values of the meter 102 and the actual values measured by reference meter 104 at the calibration points, Q₁ 210, Q₂ 212, and Q₃ 214 may be obtained by the secondary offset recalibration device 122, and the error factors, e_{qp1}, e_{qp2}, and e_{qp3}, corresponding to these calibration points may be calculated by the processors 120 and/or the secondary offset recalibration device 122. The meter 102 may then be calibrated by reading a value the meter 102 measures and applying to the value a calibration factor associated with a range of values that includes the value to yield a more accurate result. After this calibration process, measurement accuracy of the 102 meter will be adjusted to be 0% error at the calibration points and linearly adjusted between calibration points.

The calibrated value, Q_{cal}, returned by the meter 102 may be expressed in terms of the value measured, Qₘₑₐₛ, by the meter 102 and a calibration factor, K, as:

$${Q}_{ca l} = {Q}_{meas} * K , \qquad ( 1 )$$

where:

$$K = {A}_{1} * {Q}_{meas} + {B}_{1} , for {Q}_{meas} < {Q}_{1} , \qquad ( 2 )$$

$$K = {A}_{2} * {Q}_{meas} + {B}_{2} , for {Q}_{1} < {Q}_{meas} < {Q}_{2} ,$$

$$⋯$$

$$K = {A}_{n} * {Q}_{meas} + {B}_{n} , for {Q}_{n - 1} < {Q}_{meas} < {Q}_{n} .$$

A and B calibration constants of the equations (2)-(4) may be expressed as:

$${A}_{n} = ( ( \frac{1}{1 + {e}_{q n - 1}} ) - ( \frac{1}{1 + {e}_{q n}} ) ) / ( {Q}_{n - 1} - {Q}_{n} ) , \qquad ( 5 )$$

$${B}_{n} = \frac{1}{1 + {e}_{q n - 1}} - {A}_{n} * {Q}_{n - 1} . \qquad ( 6 )$$

Q_{cal} may alternatively be expressed as:

$${Q}_{c al} = {Q}_{meas} + K , \qquad ( 7 )$$

and A and B calibration constants of the equations (2)-(4) may be expressed as:

$${A}_{n} = ( {e}_{q n} - {e}_{q n - 1} ) / ( {Q}_{n} - {Q}_{n - 1} ) , \qquad ( 8 )$$

$${B}_{n} = {e}_{q n - 1} - {A}_{n} * {Q}_{n - 1} , \qquad ( 9 )$$

where the example calibrated error rate line 208 of the graph 202 is generated based on the equations (1)-(7).

For a given meter, the number, n, of calibration points may be limited by hardware. Further, a number of A and B calibration constants may also be limited by the hardware. However, in some situations, n calibration points may not be enough to provide sufficient adjustments, or calibration factors, over the entire measurement range of the meter to bring calibrated outputs within a desired measurement accuracy over the entire measurement range. When, as a result of the calibration based on the n calibration point, the meter cannot be calibrated to be within a desired measurement accuracy over the entire measurement range of the meter, the meter is typically rejected. While some of the rejected meters may be salvaged by rebuilding or refurbishing to be calibrated again, other rejected meters may be permanently removed from service, thus incurring additional cost in time and material. However, the rejected meter may be further calibrated by performing an additional calibration step, or a secondary offset calibration, to adjust the Bn value to reduce the maximum post calibration error to be within the desired measurement accuracy and center the average error of the meter measurements to be closer to 0.

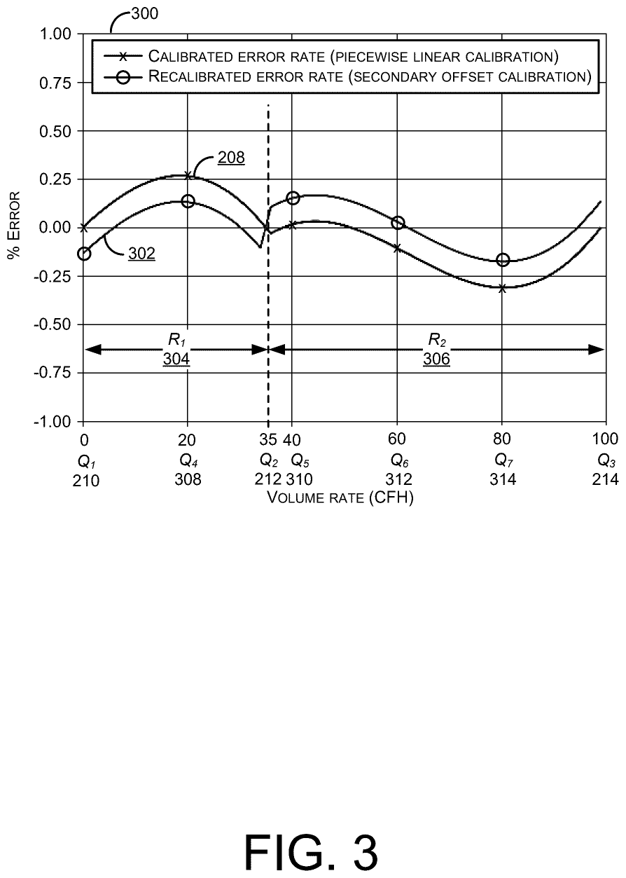

FIG. 3 illustrates a comparison graph 300 with the calibrated error rate line 208 after the piecewise linear calibration and a recalibrated error rate line 302 with a secondary offset calibration after the piecewise linear calibration. After performing the piecewise linear calibration on the meter 102, as described above with reference to FIG. 2, regions between calibration points are defined. In this example, regions R₁ 304 and R₂ 306 are defined between Q₁ 210 and Q₂ 212, and Q₂ 212 and Q₃ 214, respectively, and % error at one or more recalibration points, or post piecewise linear calibration points, in each region are measured. In this example, recalibration points, Q₄ 308 at 20 CFH, Q₅ 310 at 40 CFH, Q₆ 312 at 60 CFH, and Q₇ 314 at 80 CFH, are shown. The measurement accuracy of a given region between calibration points is then recalibrated by adjusting the B value of the region to center the measured largest and smallest accuracy values around zero. When only one value is measured in a given region either the maximum or minimum error value will be set to 0 at the calibration point. Adjusting the measurement accuracy of one region is also checked to ensure that it does not cause other measured accuracies to fall outside of the desired measurement accuracy limits.

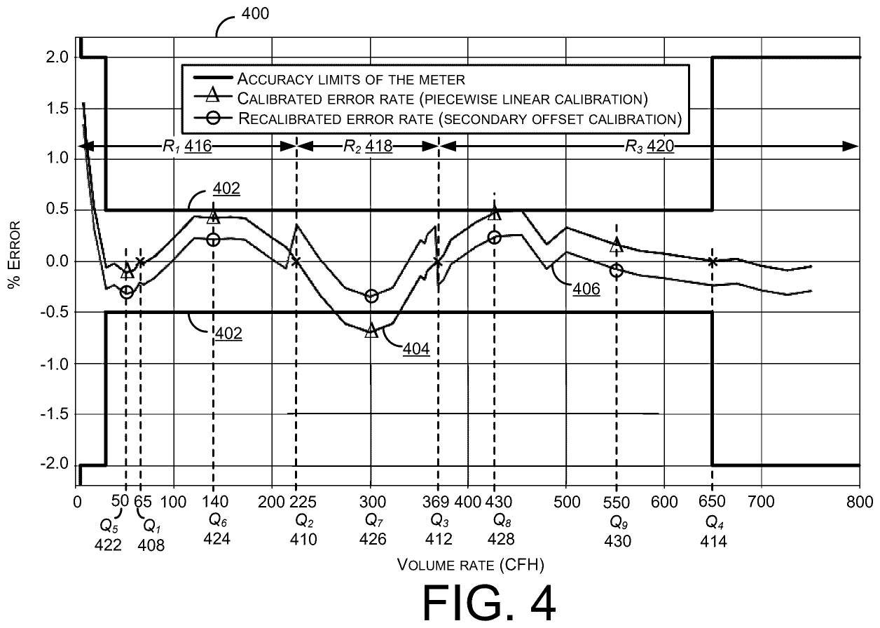

FIG. 4 illustrates a graph 400 with accuracy limits 402, which is a range of acceptable error for a given range of volume rates, of the meter 102, a calibrated error rate line 404 after the initial piecewise linear calibration, and a recalibrated error rate line 406 with a secondary offset calibration after the piecewise linear calibration. In this example, n=4, and the calibration points, Q₁ 408, Q₂ 410, Q₃ 412, and Q₄ 414 are set at 65 CFH, 225 CFH, 369 CFH, and 650 CFH, respectively. As an example, the accuracy limits 402 for this meter 102 are set as: ±2.0% for the volume rates between 5 CFH and 30 CFH, ±0.5% for the volume rates between 30 CFH and 650 CFH, and ±2.0% for the volume rates between 650 CFH and 800 CFH. As can be seen on the calibrated error rate line 404, this meter 102 would have failed the calibration due to the error rate exceeding the accuracy limit 402 around 300 CFH after the initial piecewise linear calibration with calibration constants A and B. The meter 102 would have been removed from service and/or refurbished to be calibrated again using the piecewise linear calibration, which would have incurred additional cost for the manufacturer or the user. However, the meter 102 may be re-calibrated to be within the accuracy limit 402 by utilizing the secondary offset calibration.

After the initial piecewise linear calibration, a plurality of regions may be defined based at least in part on the calibration points, and one or more recalibration points within each region may then be selected. In this example, three regions are defined: R₁ 416 between 0 CFH and Q₂ 410, R₂ 418 between Q₂ 410 and Q₃ 412, and R₃ 420 between Q₃ 412 and 800 CFH. In the region R₁ 416, two recalibration points Q₅ 422 at 50 CFH and Q₆ 424 at 140 CFH are selected; in R₂ 418, one recalibration point Q₇ 426 at 300 CFH is selected; and in R₃ 420, two recalibration points Q₈ 428 at 430 CFH and Q₉ 430 at 550 CFH are selected. Within each region, one or more error factors corresponding to the one or more recalibration points may be measured. In the region R₁ 416, two error factors e_{q5} and e_{q6} corresponding to the recalibration points Q₅ 422 and Q₆ 424 are measured; in R₂ 418, an error factor e_{q7} corresponding to the recalibration point Q₇ 426 is measured; and in R₃ 420, two error factors e_{q8} and e_{q9} corresponding to the recalibration points Q₈ 428 and Q₉ 430 are measured. In each region, a revised second calibration factor of the region is determined based on the corresponding one or more error factors and the corresponding second error factor previously determined after the initial piecewise linear calibration, and a recalibrated quantity output is generated based on a measured quantity, the first constant of the region, and the revised second calibration factor of the region. As shown in FIG. 4, the recalibrated error rate line 406 after the secondary offset calibration improves the error rate over the measurement range of the meter 102 and centers the error rate closer to 0% compared to the calibrated error rate line 404 after the initial piecewise linear calibration.

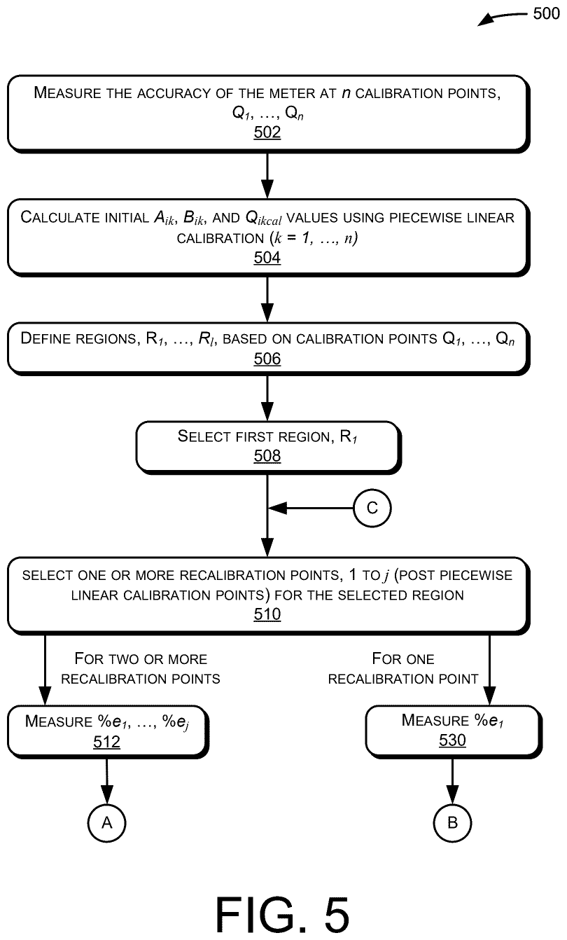

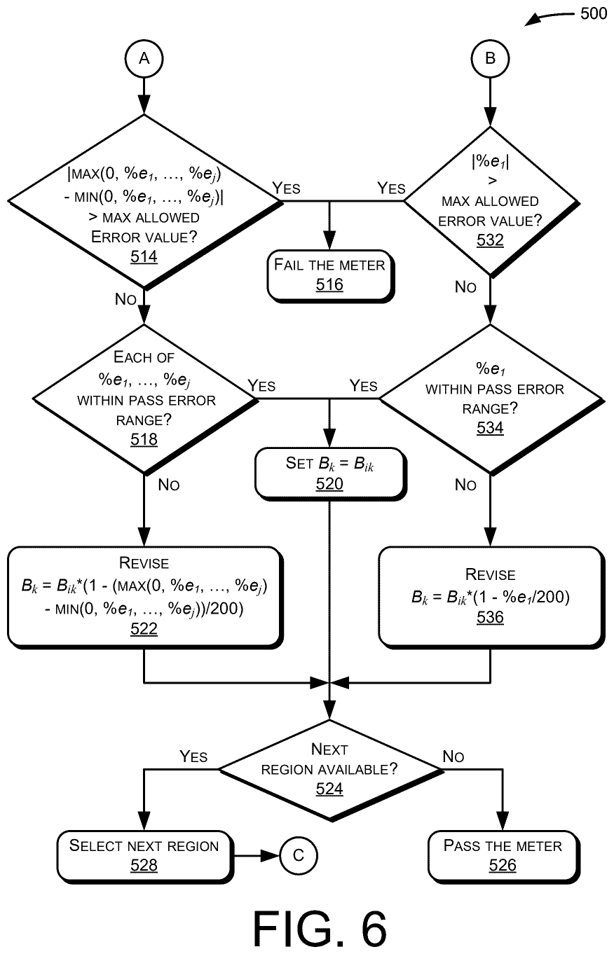

FIGS. 5 and 6 illustrate a first portion and a second portion, respectively, of an example flowchart 500 of a secondary offset calibration process of a meter, such as the meter 102, after the meter 102 is initially calibrated by utilizing the piecewise linear calibration as described above with reference to FIG. 2. The secondary offset calibration process described by the flowchart 500 may be performed by the meter calibration system 100. Blocks 502 and 504 describe the piecewise linear calibration process as described above with reference to FIG. 2.

At block 502, the measurement accuracy of the meter 102 is evaluated at n calibration points, Q₁, Q₂, . . . , Qₙ, as error factors, e_{q1}, e_{q2}, . . . , e_{qn}, where k=1 to n. In the example described above with reference to FIG. 4, n=4, and the four calibration points are Q₁ 408 at 65 CFH, Q₂ 410 at 225 CFH, Q₃ 412 at 369 CFH, and Q₄ 414 at 650 CFH. At block 504, initial Aᵢₖ, Bᵢₖ, and Q_{ikcal}, are calculated based on meter-measured quantity at the calibration points, Q₁ 408, Q₂ 410, Q₃ 412, and Q₄ 414, and the corresponding error factors, e_{q1}, e_{q2}, e_{q3}, and e_{q4}. For example, at block 502, the secondary offset recalibration device 122 may obtain the measured values of the meter 102 and the actual values measured by reference meter 104 at the calibration points, Q₁ 408 Q₂ 410, Q₃ 412, and Q₄ 414, and the processors 120 and/or the secondary offset recalibration device 122 may calculate the error factors, e_{qp1}, e_{qp2}, e_{qp3}, and e_{qp4}, corresponding to these calibration points. At block 504, the processors 120 and/or the secondary offset recalibration device 122 may calculate the initial Aᵢₖ, Bᵢₖ, and Q_{ikcal}.

The processors 120 may define a plurality of regions based at least in part on the calibration points, such as three regions R₁ 416 between 0 CFH and Q₂ 410, R₂ 418 between Q₂ 410 and Q₃ 412, and R₃ 420 between Q₃ 412 and 800 CFH shown in FIG. 4 at block 506, and may select a first region, such as the region R₁ 416 at block 508. At block 510, the processors 120 may select one or a plurality (1 to j) of recalibration points, or post piecewise linear calibration points, within the selected region. For example, a plurality of recalibration points in the region R₁ 416 may be selected at block 510, and a plurality of corresponding error factors at the plurality of recalibration points may be measured at block 512. In this example, two recalibration points, Q₅ 422 at 50 CFH and Q₆ 424 at 140 CFH are selected in the region R₁ 416 at block 510 as discussed above with reference to FIG. 4.

For these two recalibration points, corresponding error factors, e_{q5} at 50 CFH and e^{q6} at 140 CFH are measured at block 512. Referring now to FIG. 6, prior to determining a revised second calibration constant for the region R₁ 416, a combined error factor associated with the corresponding error factors, e_{q5} and e_{q6} may be evaluated at block 514 by the processors 120 and/or the secondary offset recalibration device 122. For example, the combined error factor, E_{comb}, may generally be expressed as:

$${E}_{comb} = \vert max ( 0 , \% {e}_{1} , … , \% {e}_{j} ) - min ( 0 , \% {e}_{1} , … , \% {e}_{j} ) \vert , \qquad ( 10 )$$

where %eₓ is an error factor eₓ expressed as a percentage. E_{comb} may be evaluated by determining whether E_{comb} is greater than a maximum allowed error value. The maximum allowed error value may be preselected to be a value suitable for a particular meter being calibrated. In this example, the processors 120 and/or the secondary offset recalibration device 122 may determine whether the combined error factor, E_{comb}, based on %e_{q5} and %e_{q6} is greater than the maximum allowed error value at block 514. The maximum allowed error value used, or selected, for the recalibration process may be specific to a meter, or a type of the meter, being recalibrated, and different maximum allowed error values may be used, or selected for different, or different types of, meters. In this example, the maximum allowed error value of 0.7% is used for the meter 102. In response to determining that the combined error factor, E_{comb}, is greater than 0.7% at block 514, the meter calibration system 100 may fail the meter 102 at block 516.

In response to determining that the combined error factor, E_{comb}, is not, however, greater than the maximum allowed error value of 0.7% at block 514, the processors 120 and/or the secondary offset recalibration device 122 may determine whether each of the plurality of corresponding error factors is within a pass error range at block 518. The pass error range may be preselected to be a value suitable for a particular meter being calibrated. In this example, whether both %e_{q5} and %e_{q6} are within the pass error range of ±0.3% may be determined at block 518. In other words, absolute values of %e_{q5} and %e_{q6} are compared to a pass error value of 0.3% at block 518. In response to determining that both %e_{q5} and %e_{q6} to be within the pass error range of ±0.3% at block 518, the processors 120 and/or the secondary offset recalibration device 122 may determine that no revision to the second calibration constant is necessary and, the revised second calibration constant B₁ of the region R₁ 416 may be set to the initial second calibration constant B₁ of the region R₁ 416 at block 520.

In response to determining that at least one of %e_{q5} or %e_{q6} not to be within the pass error range of ±0.3% at block 518, the revised second calibration constant B₁ of the region R₁ 416 may be set to be proportional to the initial second calibration constant Bᵢ₁ of the region R₁ 416 based on the combined error factor at block 522. For example, a revised second calibration constant Bx of the k-th region Rₖ with j recalibration points may be generally expressed as:

$${B}_{k} = {B}_{i k} * ( 1 - \frac{max ( 0 , \% {e}_{1} , … , \% {e}_{j} ) - min ( 0 , \% {e}_{1} , … , \% {e}_{j} )}{200} ) , \qquad ( 11 )$$

where j is the number of the plurality of recalibration points. For the region R₁ 416 with two recalibration points with two corresponding error factors, e_{q5} and e_{q6}, the revised second calibration constant B₁ is:

$${B}_{1} = {B}_{i 1} * ( 1 - \frac{max ( 0 , \% {e}_{q 5} , \% {e}_{q 6} ) - min ( 0 , \% {e}_{q 5} , \% {e}_{q 6} )}{200} ) . \qquad ( 12 )$$

After the revised second calibration constant B₁ is determined at block 520 or 522 as described above, whether a next region is available is checked at block 524. If no next region is determined to be available, then the secondary offset calibration process is completed at block 526 where the meter 102 has successfully passed, or recalibrated, with the revised second calibration constant B₁. In this example, however, there are still two more regions, R₂ 418 and R₃ 420, available after the region R₁ 416, and a next region, the region R₂ 418, may be selected at block 528. The process then loops back to block 510, where one or a plurality (1 to j) of recalibration points within the region R₂ 418 may be selected. In this example, one recalibration point, Q₇ 426 at 300 CFH in the region R₂ 418, may be selected at block 510, and an error factor e_{q7} at Q₇ 426 may be measured at block 530 as discussed above with reference to FIG. 4.

Prior to determining a revised second calibration constant for the region R₂ 418, the error factor e_{q7} may be evaluated at block 532. In this example, whether an absolute value of the error factor e_{q7} is greater than the maximum allowed error value of 0.7% may be determined at block 532. In response to determining that the absolute value of the error factor e_{g7} is greater than the maximum allowed error value of 0.7% at block 532, the meter 102 may be failed a block 516.

In response to determining that the absolute value of the error factor, e_{q7}, however, is not greater than the maximum allowed error value of 0.7% at block 532, whether the error factor, e_{q7}, is within a pass error range may be determined at block 534. In this example, whether %e_{q7} is within the pass error range of ±0.3% may be determined at block 534. In other words, an absolute value of %e_{q7} is compared to a pass error value of 0.3% at block 534. In response to determining %e_{q7} to be within the pass error range of ±0.3% at block 534, no revision to the second calibration constant is deemed necessary and, the revised second calibration constant B₂ of the region R₂ 418 may be set to the initial second calibration constant Bᵢ₂ of the region R₂ 418 at block 520.

In response to determining %e_{q7} not to be within the pass error range of ±0.3% at block 534, the revised second calibration constant B₂ of the region R₂ 418 may be set to be proportional to the initial second calibration constant Bᵢ₂ of the region R₂ 418 based on the error factor e_{q7} at block 536. For example, a revised second calibration constant Bx of the k-th region Rx with one recalibration point may be generally expressed as:

$${B}_{k} = {B}_{ik} * ( 1 - \frac{\% {e}_{1}}{200} ) . \qquad ( 13 )$$

For the region R₂ 418 with one recalibration point with the corresponding error factor, e_{q7}, the revised second calibration constant B₂ is:

$${B}_{2} = {B}_{i 2} * ( 1 - \frac{\% {e}_{q 7}}{200} ) . \qquad ( 14 )$$

After the revised second calibration constant B₂ is determined at block 520 or 522 as described above, whether a next region is available is checked at block 524. If no next region is determined to be available, then the secondary offset calibration process is completed at block 526 where the meter 102 has successfully passed, or recalibrated, with the revised second calibration constants B₁ and B₂. In this example, after the region R₂ 418, there is one more region R₃ 420 available, and a next region, the region R₃ 420, may be selected at block 528. The process then loops back to block 510, where one or a plurality (1 to j) of recalibration points within the region R₃ 420 may be selected. In this example, a plurality of recalibration points in the region R₃ 420 may be selected at block 510, and a plurality of corresponding error factors at the plurality of recalibration points may be measured at block 512.

In this example, two recalibration points, Q₈ 428 at 430 CFH and Q₉ 430 at 550 CFH are selected in the region R₃ 420 at block 510 as discussed above with reference to FIG. 4. For these two recalibration points, corresponding error factors, e_{q8} at 430 CFH and e_{q9} at 550 CFH are measured at block 512. Prior to determining a revised second calibration constant for the region R₃ 420, the combined error factor, E_{comb}, associated with the corresponding error factors, e_{q8} and e_{q9} may be evaluated at block 514. In this example, whether the combined error factor, E_{comb}, based on %e_{q8} and %e_{q9} is greater than the maximum allowed error value of 0.7% may be determined at block 514. In response to determining that the combined error factor, E_{comb}, is greater than 0.7% at block 514, the meter 102 may be failed at block 516.

In response to determining that the combined error factor, E_{comb}, is not, however, greater than the maximum allowed error value of 0.7% at block 514, whether each of the plurality of corresponding error factors is within a pass error range may be determined at block 518. In this example, whether both %e_{q8} and %e_{q9} are within the pass error range of ±0.3% may be determined at block 518. As described above with reference to the region R₁ 416, absolute values of %e_{q8} and %e_{q9} are compared to a pass error value of 0.3% at block 518. In response to determining that both %e_{q8} and %e_{q9} to be within the pass error range of ±0.3% at block 518, no revision to the second calibration constant is deemed necessary and, the revised second calibration constant B₃ of the region R₃ 420 may be set to the initial second calibration constant Bᵢ₃ of the region R₃ 420 at block 520.

In response to determining at least one of %e_{q8} or %e_{q9} not to be within the pass error range of ±0.3% at block 518, the revised second calibration constant B₃ of the region R₃ 420 may be set to be proportional to the initial second calibration constant Bᵢ₃ of the region R₃ 420 based on the combined error factor, E_{comb}, of the region R₃ 420 at block 522 as:

$${B}_{3} = {B}_{i 3} * ( 1 - \frac{max ( 0 , \% {e}_{q 8} , \% {e}_{q 9} ) - min ( 0 , \% {e}_{q 8} , \% {e}_{q 9} )}{200} ) . \qquad ( 15 )$$

After the revised second calibration constant B₃ is determined at block 520 or 522 as described above, whether a next region is available is checked at block 524. Because there are no more regions available after the region R₃ 420, then the secondary offset calibration process is completed at block 526 where the meter 102 has successfully passed, or recalibrated, with the revised second calibration constants B₁, B₂, and B₃. The meter 102 may now generate, or output, the recalibrated quantity output, Q_{cal}, based on a measured quantity, Qₘₑₐₛ, output, the first calibration constants, A₁, A₂, and A₃, and the revised second calibration constants B₁, B₂, and B₃. Additionally, the first calibration constant A and the revised second calibration constant B for each region of the plurality of regions may be stored in the meter 102 and used by the meter 102 for generating the recalibrated quantity output of the meter 102.

Some or all operations of the methods described above can be performed by execution of computer-readable instructions stored on a computer-readable storage medium, as defined below. The terms “computer-readable medium,” “computer-readable instructions,” “computer-executable instructions,” and “processor-executable instructions” as used in the description and claims, include routines, applications, application modules, program modules, programs, components, data structures, algorithms, and the like. Computer-readable and -executable instructions and processor-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media, such as the memory 124, when executed by one or more processors, such as the processors 120, may perform operations described above with reference to FIGS. 1-6. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### EXAMPLE CLAUSES

A. A method for improving measurement accuracy of a meter previously calibrated includes: defining a region over a measurement range of the meter based at least in part on a plurality of calibration points utilized to previously calibrate the meter, the region having a first calibration constant and a second calibration constant; recalibrating a quantity output of the meter by: 1) selecting one or more recalibration points within the region, 2) measuring one or more corresponding error factors at the one or more recalibration points, 3) determining a revised second calibration constant based on the one or more corresponding error factors and the second calibration constant; and 4) generating the recalibrated quantity output of the meter based on a measured quantity output by the meter, the first calibration constant, and the revised second calibration constant.

B. The method of example A, wherein prior to the recalibrating, the meter is previously calibrated using a piecewise linear calibration.

C. The method of example B, wherein selecting the one or more recalibration points within the region includes selecting a plurality of recalibration points within the region, measuring the one or more corresponding error factors at the one or more recalibration points includes measuring a plurality of corresponding error factors at the plurality of recalibration points, and prior to determining the revised second calibration constant, the method further includes: determining whether a combined error factor associated with the plurality of corresponding error factors is greater than a maximum allowed error value; and in response to determining that the combined error factor is greater than the maximum allowed error value, failing the meter.

D. The method of example C, wherein the combined error factor is calculated as an absolute value of a difference between a maximum value among the plurality of corresponding error factors and zero and a minimum value among the plurality of corresponding error factors and zero.

E. The method of example C, further includes, in response to determining that the combined error factor is not greater than the maximum allowed error value, determining that each of the plurality of corresponding error factors is within a pass error range, wherein determining the revised second calibration constant includes setting the second calibration constant as the revised second calibration constant.

F. The method of example C, further includes, in response to determining that the combined error factor is not greater than the maximum allowed error value, determining that at least one of the plurality of corresponding error factors is not within a pass error range, wherein determining the revised second calibration constant includes setting the revised second calibration constant proportional to the second calibration constant based on the combined error factor.

G. The method of example B, wherein selecting the one or more recalibration points within the region includes selecting one recalibration point within the region, measuring the one or more corresponding error factors at the one or more recalibration points includes measuring an error factor at the one recalibration point, and prior to determining the revised second calibration constant, the method further includes: determining whether the error factor is greater than a maximum allowed error value; and in response to determining that the error factor is greater than the maximum allowed error value, failing the meter.

H. The method of example G, further includes: in response to determining that the error factor is not greater than the maximum allowed error value, determining that the error factor is within a pass error range, wherein determining the revised second calibration constant includes setting the second calibration constant as the revised second calibration constant.

I. The method of example G, further includes: in response to determining that the error factor is not greater than the maximum allowed error value, determining that the error factor is not within a pass error range, wherein determining the revised second calibration constant includes setting the revised second calibration constant proportional to the second calibration constant based on the error factor.

J. The method of example A, wherein: the region is a first region of a plurality of regions defined over the measurement range of the meter based on the plurality of calibration points utilized to previously calibrate the meter and each region of the plurality of regions has a corresponding first calibration constant and a corresponding second calibration constant, and the method further includes selecting a next region of the plurality of regions if the next region is available and repeating the recalibrating for the next region.

K. A non-transitory computer-readable storage medium storing thereon computer executable instructions that, when executed by one or more processors, cause the one or more processors to perform operations for improving measurement accuracy of a meter previously calibrated, the operations includes: defining a region over a measurement range of the meter based at least in part on a plurality of calibration points utilized to previously calibrate the meter, the region having a first calibration constant and a second calibration constant; recalibrating a quantity output of the meter by: 1) selecting one or more recalibration points within the region; 2) measuring one or more corresponding error factors at the one or more recalibration points; 3) determining a revised second calibration constant based on the one or more corresponding error factors and the second calibration constant; and generating the recalibrated quantity output of the meter based on a measured quantity output by the meter, the first calibration constant, and the revised second calibration constant.

L. The non-transitory computer-readable storage medium of example K, wherein: selecting the one or more recalibration points within the region includes selecting a plurality of recalibration points within the region; measuring the one or more corresponding error factors at the one or more recalibration points includes measuring a plurality of corresponding error factors at the plurality of recalibration points; and the operations further include prior to determining the revised second calibration constant: determining whether a combined error factor associated with the plurality of corresponding error factors is greater than a maximum allowed error value; and in response to determining that the combined error factor is greater than the maximum allowed error value, failing the meter.

M. The non-transitory computer-readable storage medium of example L, wherein the operations further include: in response to determining that the combined error factor is not greater than the maximum allowed error value: determining that each of the plurality of corresponding error factors is within a pass error range, wherein determining the revised second calibration constant includes setting the second calibration constant as the revised second calibration constant; or determining that at least one of the plurality of corresponding error factors is not within the pass error range, wherein determining the revised second calibration constant includes setting the revised second calibration constant proportional to the second calibration constant based on the combined error factor.

N. The non-transitory computer-readable storage medium of example K, wherein: selecting the one or more recalibration points within the region includes selecting one recalibration point within the region; measuring the one or more corresponding error factors at the one or more recalibration points includes measuring an error factor at the one recalibration point; and the operations further include, prior to determining the revised second calibration constant: determining whether the error factor is greater than a maximum allowed error value; and in response to determining that the error factor is greater than the maximum allowed error value, failing the meter.

O. The non-transitory computer-readable storage medium of example N, wherein the operations further include, in response to determining that the error factor is not greater than the maximum allowed error value: determining that the error factor is within a pass error range, wherein determining the revised second calibration constant includes setting the second calibration constant as the revised second calibration constant; or determining that the error factor is not within the pass error range, wherein determining the revised second calibration constant includes setting the revised second calibration constant proportional to the second calibration constant based on the error factor.

P. The non-transitory computer-readable storage medium of example K, wherein the region is a first region of a plurality of regions defined over the measurement range of the meter based on the plurality of calibration points utilized to previously calibrate the meter, and each region of the plurality of regions has a corresponding first calibration constant and a corresponding second calibration constant; and the operations further include selecting a next region of the plurality of regions if the next region is available, and repeating the recalibrating for the next region.

Q. A calibration system includes: a reference meter; a flow regulator coupled to the reference meter; one or more processors; an input/output (I/O) device coupled to the reference meter, the flow regulator, and the one or more processors; and memory coupled to the one or more processors, the memory storing thereon computer-executable instructions that, when executed by the one or more processors, cause the one or more processors to perform operations, the operations including: defining a region over a measurement range of a meter based at least in part on a plurality of calibration points utilized to previously calibrate the meter, the region having a first calibration constant and a second calibration constant, the meter coupled to the I/O device and the reference meter; recalibrating a quantity output of the meter by: 1) selecting one or more recalibration points within the region, 2) setting, by the flow regulator via the I/O device, the one or more recalibration points, 3) measuring, by the reference meter and the meter via the I/O device, one or more corresponding error factors at the one or more recalibration points, and 4) determining a revised second calibration constant based on the one or more corresponding error factors and the second calibration constant; and storing, in the meter, the first calibration constant and the revised second calibration constant, to be used by the meter for generating the recalibrated quantity output of the meter based on a measured quantity output by the meter.

R. The system of example Q, wherein: selecting the one or more recalibration points within the region includes selecting a plurality of recalibration points within the region; measuring the one or more corresponding error factors at the one or more recalibration points includes measuring a plurality of corresponding error factors at the plurality of recalibration points; and the operations further include, prior to determining the revised second calibration constant: determining whether a combined error factor associated with the plurality of corresponding error factors is greater than a maximum allowed error value; in response to determining that the combined error factor is greater than the maximum allowed error value, failing the meter; in response to determining that the combined error factor is not greater than the maximum allowed error value: determining that each of the plurality of corresponding error factors is within a pass error range, wherein determining the revised second calibration constant includes setting the second calibration constant as the revised second calibration constant; or determining that at least one of the plurality of corresponding error factors is not within the pass error range, wherein determining the revised second calibration constant includes setting the revised second calibration constant proportional to the second calibration constant based on the combined error factor.

S. The calibration system of example Q, wherein: selecting the one or more recalibration points within the region includes selecting one recalibration point within the region; measuring the one or more corresponding error factors at the one or more recalibration points includes measuring an error factor at the one recalibration point; and the operations further include, prior to determining the revised second calibration constant: determining whether the error factor is greater than a maximum allowed error value; in response to determining that the error factor is greater than the maximum allowed error value, failing the meter; and in response to determining that the error factor is not greater than the maximum allowed error value: determining that the error factor is within a pass error range, wherein determining the revised second calibration constant includes setting the second calibration constant as the revised second calibration constant, or determining that the error factor is not within the pass error range, wherein determining the revised second calibration constant includes setting the revised second calibration constant proportional to the second calibration constant based on the error factor.

T. The calibration system of example Q, wherein: the region is a first region of a plurality of regions defined over the measurement range of the meter based on the plurality of calibration points utilized to previously calibrate the meter, and each region of the plurality of regions has a corresponding first calibration constant and a corresponding second calibration constant, and the operations further include: selecting a next region of the plurality of regions if the next region is available; and repeating the recalibrating for the next region.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for improving measurement accuracy of a meter previously calibrated, the method comprising:
defining a region over a measurement range of the meter based at least in part on a plurality of calibration points utilized to previously calibrate the meter, the region having a first calibration constant and a second calibration constant;
recalibrating a quantity output of the meter by:
selecting one or more recalibration points within the region,
measuring one or more corresponding error factors at the one or more recalibration points,
determining a revised second calibration constant based on:
the one or more corresponding error factors, and
the second calibration constant; and
generating the recalibrated quantity output of the meter based on a measured quantity output by the meter, the first calibration constant, and the revised second calibration constant.

2. The method of claim 1, wherein prior to the recalibrating, the meter is previously calibrated using a piecewise linear calibration.

3. The method of claim 2, wherein:
selecting the one or more recalibration points within the region includes selecting a plurality of recalibration points within the region,
measuring the one or more corresponding error factors at the one or more recalibration points includes measuring a plurality of corresponding error factors at the plurality of recalibration points, and
prior to determining the revised second calibration constant, the method further comprises:
determining whether a combined error factor associated with the plurality of corresponding error factors is greater than a maximum allowed error value; and
in response to determining that the combined error factor is greater than the maximum allowed error value, failing the meter.

4. The method of claim 3, wherein the combined error factor is calculated as an absolute value of a difference between:
a maximum value among the plurality of corresponding error factors and zero, and
a minimum value among the plurality of corresponding error factors and zero.

5. The method of claim 3, further comprising:
in response to determining that the combined error factor is not greater than the maximum allowed error value, determining that each of the plurality of corresponding error factors is within a pass error range,
wherein determining the revised second calibration constant includes setting the second calibration constant as the revised second calibration constant.

6. The method of claim 3, further comprising:
in response to determining that the combined error factor is not greater than the maximum allowed error value, determining that at least one of the plurality of corresponding error factors is not within a pass error range,
wherein determining the revised second calibration constant includes setting the revised second calibration constant proportional to the second calibration constant based on the combined error factor.

7. The method of claim 2, wherein:
selecting the one or more recalibration points within the region includes selecting one recalibration point within the region,
measuring the one or more corresponding error factors at the one or more recalibration points includes measuring an error factor at the one recalibration point, and
prior to determining the revised second calibration constant, the method further comprises:
determining whether the error factor is greater than a maximum allowed error value; and
in response to determining that the error factor is greater than the maximum allowed error value, failing the meter.

8. The method of claim 7, further comprising:
in response to determining that the error factor is not greater than the maximum allowed error value, determining that the error factor is within a pass error range,
wherein determining the revised second calibration constant includes setting the second calibration constant as the revised second calibration constant.

9. The method of claim 7, further comprising:
in response to determining that the error factor is not greater than the maximum allowed error value, determining that the error factor is not within a pass error range,
wherein determining the revised second calibration constant includes setting the revised second calibration constant proportional to the second calibration constant based on the error factor.

10. The method of claim 1, wherein:
the region is a first region of a plurality of regions defined over the measurement range of the meter based on the plurality of calibration points utilized to previously calibrate the meter, and
each region of the plurality of regions has a corresponding first calibration constant and a corresponding second calibration constant, and
the method further comprises:
selecting a next region of the plurality of regions if the next region is available; and
repeating the recalibrating for the next region.

11. A non-transitory computer-readable storage medium storing thereon computer executable instructions that, when executed by one or more processors, cause the one or more processors to perform operations for improving measurement accuracy of a meter previously calibrated, the operations comprising:
defining a region over a measurement range of the meter based at least in part on a plurality of calibration points utilized to previously calibrate the meter, the region having a first calibration constant and a second calibration constant;
recalibrating a quantity output of the meter by:
selecting one or more recalibration points within the region,
measuring one or more corresponding error factors at the one or more recalibration points, and
determining a revised second calibration constant based on:
the one or more corresponding error factors, and
the second calibration constant; and
generating the recalibrated quantity output of the meter based on a measured quantity output by the meter, the first calibration constant, and the revised second calibration constant.

12. The non-transitory computer-readable storage medium of claim 11, wherein:
selecting the one or more recalibration points within the region includes selecting a plurality of recalibration points within the region;
measuring the one or more corresponding error factors at the one or more recalibration points includes measuring a plurality of corresponding error factors at the plurality of recalibration points; and
the operations further comprise, prior to determining the revised second calibration constant:
determining whether a combined error factor associated with the plurality of corresponding error factors is greater than a maximum allowed error value; and
in response to determining that the combined error factor is greater than the maximum allowed error value, failing the meter.

13. The non-transitory computer-readable storage medium of claim 12, wherein the operations further comprise:
in response to determining that the combined error factor is not greater than the maximum allowed error value:
determining that each of the plurality of corresponding error factors is within a pass error range, wherein determining the revised second calibration constant includes setting the second calibration constant as the revised second calibration constant; or
determining that at least one of the plurality of corresponding error factors is not within the pass error range, wherein determining the revised second calibration constant includes setting the revised second calibration constant proportional to the second calibration constant based on the combined error factor.

14. The non-transitory computer-readable storage medium of claim 11, wherein:
selecting the one or more recalibration points within the region includes selecting one recalibration point within the region;
measuring the one or more corresponding error factors at the one or more recalibration points includes measuring an error factor at the one recalibration point; and
the operations further comprise, prior to determining the revised second calibration constant:
determining whether the error factor is greater than a maximum allowed error value; and
in response to determining that the error factor is greater than the maximum allowed error value, failing the meter.

15. The non-transitory computer-readable storage medium of claim 14, wherein the operations further comprise:
in response to determining that the error factor is not greater than the maximum allowed error value:
determining that the error factor is within a pass error range, wherein determining the revised second calibration constant includes setting the second calibration constant as the revised second calibration constant; or
determining that the error factor is not within the pass error range, wherein determining the revised second calibration constant includes setting the revised second calibration constant proportional to the second calibration constant based on the error factor.

16. The non-transitory computer-readable storage medium of claim 11, wherein:
the region is a first region of a plurality of regions defined over the measurement range of the meter based on the plurality of calibration points utilized to previously calibrate the meter, and
each region of the plurality of regions has a corresponding first calibration constant and a corresponding second calibration constant, and
the operations further comprise:
selecting a next region of the plurality of regions if the next region is available; and
repeating the recalibrating for the next region.

17. A calibration system comprising:
a reference meter;
a flow regulator coupled to the reference meter;
one or more processors;
an input/output (I/O) device coupled to the reference meter, the flow regulator, and the one or more processors; and
memory coupled to the one or more processors, the memory storing thereon computer-executable instructions that, when executed by the one or more processors, cause the one or more processors to perform operations, the operations comprising:
defining a region over a measurement range of a meter based at least in part on a plurality of calibration points utilized to previously calibrate the meter, the region having a first calibration constant and a second calibration constant, the meter coupled to the I/O device and the reference meter;
recalibrating a quantity output of the meter by:
selecting one or more recalibration points within the region,
setting, by the flow regulator via the I/O device, the one or more recalibration points,
measuring, by the reference meter and the meter via the I/O device, one or more corresponding error factors at the one or more recalibration points, and
determining a revised second calibration constant based on:
the one or more corresponding error factors, and
the second calibration constant; and
storing, in the meter, the first calibration constant and the revised second calibration constant, to be used by the meter for generating the recalibrated quantity output of the meter based on a measured quantity output by the meter.

18. The calibration system of claim 17, wherein:
selecting the one or more recalibration points within the region includes selecting a plurality of recalibration points within the region;
measuring the one or more corresponding error factors at the one or more recalibration points includes measuring a plurality of corresponding error factors at the plurality of recalibration points; and
the operations further comprise, prior to determining the revised second calibration constant:
determining whether a combined error factor associated with the plurality of corresponding error factors is greater than a maximum allowed error value;
in response to determining that the combined error factor is greater than the maximum allowed error value, failing the meter; and
in response to determining that the combined error factor is not greater than the maximum allowed error value:
determining that each of the plurality of corresponding error factors is within a pass error range, wherein determining the revised second calibration constant includes setting the second calibration constant as the revised second calibration constant; or
determining that at least one of the plurality of corresponding error factors is not within the pass error range, wherein determining the revised second calibration constant includes setting the revised second calibration constant proportional to the second calibration constant based on the combined error factor.

19. The calibration system of claim 17, wherein:
selecting the one or more recalibration points within the region includes selecting one recalibration point within the region;
measuring the one or more corresponding error factors at the one or more recalibration points includes measuring an error factor at the one recalibration point; and
the operations further comprise, prior to determining the revised second calibration constant:
determining whether the error factor is greater than a maximum allowed error value;
in response to determining that the error factor is greater than the maximum allowed error value, failing the meter; and
in response to determining that the error factor is not greater than the maximum allowed error value:
determining that the error factor is within a pass error range, wherein determining the revised second calibration constant includes setting the second calibration constant as the revised second calibration constant, or
determining that the error factor is not within the pass error range, wherein determining the revised second calibration constant includes setting the revised second calibration constant proportional to the second calibration constant based on the error factor.

20. The calibration system of claim 17, wherein:
the region is a first region of a plurality of regions defined over the measurement range of the meter based on the plurality of calibration points utilized to previously calibrate the meter, and
each region of the plurality of regions has a corresponding first calibration constant and a corresponding second calibration constant, and
the operations further comprise:
selecting a next region of the plurality of regions if the next region is available; and
repeating the recalibrating for the next region.
